(19) United States
(12) Patent Application Publication
(10) Pub. No.: US 2006/0173813 A1
(43) Pub. Date: Aug. 3, 2006

(54) System and method of providing ad hoc query capabilities to complex database systems

(75) Inventor: Marcos Zorola, San Antonio, TX (US)

Correspondence Address: WILLIAM B. NASH;Jackson Walker, LLP, Suite 2100, 112 E. Pecan, San Antonio, TX, 78205, US

(73) Assignee: SAN ANTONIO INDEPENDENT SCHOOL DISTRICT

(21) Appl. No.: 11/325,183

(22) Filed: Jan. 4, 2006

Related U.S. Application Data
(60) Provisional application No. 60/641,334, filed on Jan. 4, 2005.

(51) Int. Cl. G06F 17/30

(52) U.S. Cl. 707/2

(57) ABSTRACT

A system and method for providing ad hoc query capabilities to complex homogenous and heterogeneous database systems. The method utilizes a universal join table adapted to join with any table within a database system or across multiple database systems. Using the universal join table, a logical flat hierarchy is laid on top of the database system to simplify complex searches across one or more database systems.

This application claims priority from U.S. Application No. 60/641,334 filed Jan. 4, 2005 and incorporates by reference the '334 application as if it were fully printed herein.

### FIELD OF THE INVENTION

Applicant's invention relates to a system and method for querying database systems for stored information. More particularly, Applicant's invention relates to a system and method for providing ad hoc query capabilities to a homogenous or heterogeneous group of database tables which may reside on one or more networked computers.

### BACKGROUND OF THE INVENTION

The methods used to link data from various databases and/or tables have generally involved the use of primary keys that must exist in each table to permit the joining of those tables. This can be problematic and inefficient in some circumstances. As the number of tables increases, the level of complexity to join any two or more of those tables also increases; the standard approach of joining tables in a nested parent to child form rapidly becomes too complex. In addition, as the number of tables available for querying becomes larger, the increased logic and decreased efficiency of the queries becomes a bottleneck for all processing. The complexity and performance bottleneck serve to reduce or eliminate the availability of ad hoc query capabilities across multiple tables.

A simple method for linking various tables within a database or across multiple databases and at different points in time is needed. Additionally a very flexible scheme for grouping and sorting data is needed.

It is therefore an object of this invention to provide a system and method which permits ad hoc queries that can span multiple tables and multiple databases without requiring complex database structures and while masking the complexity of the search from the user.

It is a further object of the present invention to provide a system and method which enables fast linking of various tables, either within a database or across multiple databases, utilizing a central common binding table. This binding table acts as the common binding element for all tables to be used in a query. The binding table permits the joining of disparate tables which may lack the requisite common elements to be joined directly one to the other.

It is yet a further object of the present invention to provide a system and method which includes a grouping table, used in conjunction with the binding table, to act as a record filter to limit or restrict the result set of a query.

### SUMMARY OF THE INVENTION

In accordance with the invention, a system for providing ad hoc query capabilities to a homogenous or heterogeneous group of database tables is provided which is comprised of a binding table configured to function as a common or universal joining mechanism for each of a plurality of data tables; a relations table to store generic code required to join the binding table to each of the plurality of data tables; a grouping table to limit the result set of a search and providing logical grouping information for the fields of the plurality of data tables to a user wherein the grouping table stores at least a group identifier, a joining key, and a group field. Additionally, means are provided for interacting with a user to select one or more fields from one or more data tables to be queried and to define conditional statements to filter the search result set from the queried tables. Finally, a means for displaying the results of a search to the user is provided.

When an ad hoc query is requested by user, the user is presented with a list of the logical groups of fields across the entire system which may be searched by the user. An example of a logical group would be “demographics.” Examples of fields which may populate the demographic group are street address, city, zip code, gender, and race. When the user selects a group, the user is then presented with the list of fields comprising the group. Upon selecting a field, the user is given the opportunity to limit the result set by applying conditionals to the searched field. A conditional is a limit applied to a search field to restrict the result set of a search. For example, a condition applied to elementary school grade levels might be limiting from grades 1 through 3. The user repeats this process until all desired fields have been selected and the search is initiated.

Once the search is initiated, a main or base table is identified. The base table is determined by the query selected by the user; that is, the table containing the data the user wishes returned from the defined search. For example, if the query is for demographic data, the base table will be that table that contains that data. The query page passes the base table to subsequent processing. The data binding process is a function that has three inputs: a base table, a conditional statement that references exclusively the base table, and a field list containing fields from any of a number of tables that have been prepared for use within the system. The search results of the base table are used to limit the search of subsequent tables. Each field identified by the user is reviewed and a list of tables required for the search is created. These tables are then programmatically linked to the universal binding table. If a grouping condition was requested by the user, an additional join against the universal binding table is performed which removes all returned records which are not in the group.

In a typical scenario, a query begins with a question which requires an answer. For example, a user in a school district wants to know the names and attendance rates for all 3rd grade children who failed a standardized test on its first administration in 2004. In this example, the base table is the table which stores the results of the standardized test. The conditional statement would be a string containing the fields and values to limit the base table to only the 3rd grade students who failed the standardized test during the first administration of 2004. For this example the field list is comprised of the student names and the student attendance rate. These fields are accessed from tables which are not part of the standardized test data, i.e. a student table and an attendance table. All fields in the field list also contain the name of the table containing the field. This example scenario will be used below to fully explain the present invention.

When the user of the above scenario has identified the base table, the desired fields, and the conditions upon the returned data set, the system creates a table list. The table list contains a unique list of all the tables for each field in the field list. For example, if the user in the above example also wanted to return the student's gender, since that field would be stored along with the student's name, there would be only one entry in the table list for the two fields.

The table list is first populated with the universal binding table. The next entry is populated with the base table. Next, each field in the field list is interrogated and the field's table is checked against the table list. If the table is not in the table list, it is inserted at the end thereof. In the example above, the student table and attendance table would also be added to the list. As each table is added to the list a unique table qualifier is also added—this qualifier will be used to qualify the fields in the select statement. A table qualifier is a sequence of letters and/or numbers that will be assigned to the table as SQL table qualifiers for use in the final constructed query statement. Because a column (field) in a table can be referred to by its name alone only if it is the only column by that name in all the tables listed in a query, if the same column name exists in more than one table or view in the query expression, the query will fail without qualification. Qualifying a column is accomplished by a reference to the table that contains column (field). By assigning a unique qualifier to each table, the system can easily link the fields back to the appropriate tables should the same field name appear in more than one table.

After all fields have been interrogated and the complete table list formed, the table list is processed to create the appropriate join statement. Beginning with the second table in the table list, the base table, the relations table is queried for the generic code to create the link between the first table, the binding table, and the table to be joined. The relations table stores generic SQL code required to join any of the tables in the system to the binding table. This generic SQL code is retrieved and processed so that the linking fields are prefixed with the correct table qualifiers as stored in the table list. The modified SQL code is then added to the SQL statement join clause. Each subsequent table in the table list is processed in this fashion. Lastly the grouping table is queried to limit the result set of the generated query and added to the join statement and the group value conditional is added to the generated WHERE clause of the SQL code. A WHERE clause in an SQL statement allows the SQL database system to filter the results of an SQL statement.

The field list is then processed to create the SELECT portion of the SQL statement. A SQL SELECT clause specifies the fields, constants, and expressions to display in the query results. Each field is prefixed with the appropriate table qualifier, as defined in the table list. The WHERE clause is assembled from the chosen conditionals and the group conditions are added as required by the user. The result is a formatted SQL statement with the fields for the SELECT statement, the joins, and the conditions.

The generated SQL statement is then passed to the database system and the result set is displayed for the user.

### BRIEF DESCRIPTION OF THE DRAWINGS

FIG. 1 depicts a pictorial representation of a network comprising one or more database systems in which the present invention may be implemented.

FIG. 2 is a hierarchy chart illustrating the typical hierarchical structure of a modern database system.

FIG. 3 is a hierarchy chart illustrating the single layer hierarchy logically applied to an existing database system by the present invention.

FIG. 4 is a flowchart of processing performed by the present invention.

FIG. 5 is a flowchart illustrating processing performed by the present invention to retrieve the fields the user would like to search or retrieve.

FIG. 6 is a flowchart illustrating processing performed by the present invention to convert the user's field selection into SQL query code.

### DETAILED DESCRIPTION OF THE PREFERRED EMBODIMENT

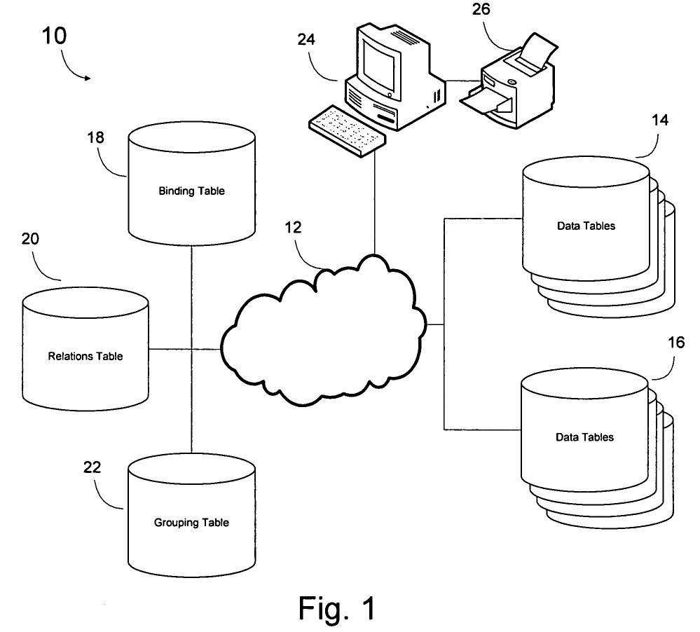

Referring to the figures in which like referenced features indicate corresponding elements throughout the several views, attention is first directed to FIG. 1 which depicts a pictorial representation of a local area or wide area network (12) comprising one or more database systems in which the present invention may be implemented. Existing database systems (14 and 16) store data relevant to a particular group or organization. Typically, the database systems (14 and 16) are relational database systems. It is contemplated that the present invention may structure and perform queries across a single database or across separate databases residing on the same or separate servers. The binding table (18) is configured such that it is an appropriate join target for any table in the database systems (14 and 16). Through the binding table (18), separate tables which may not otherwise be compatible, may be joined. The relations table (20) stores generic code required to join the binding table to each of the plurality of data tables. This generic code includes field mapping information and key field information. The grouping table (22) provides logical grouping information for the fields of the plurality of data tables; this information is provided to a user via an interface device such as a computer workstation (24). The grouping table (22) is comprised of at least three fields: a unique identifier for a group, a key field used to join the grouping table to the binding table, and a group value field. The group value is a conditional that is used to limit the records returned in a result set by restricting the result set to members of the defined group.

A printing device (26) may be used as an output device for retrieved search results. The computer workstation (24) may also be, and is commonly, used as the display device for the retrieved search results. Although shown in FIG. 1 as a typical desktop computer, computer workstation (24) is also contemplated as being any computerized device which may access a computer network, accept input from a user, and present output to a user. Examples of alternative devices include laptop computers, “dumb” terminals, personal digital assistants, interactive mobile phones, voice devices such as telephones, and any other device which may interact with a human or electronic user.

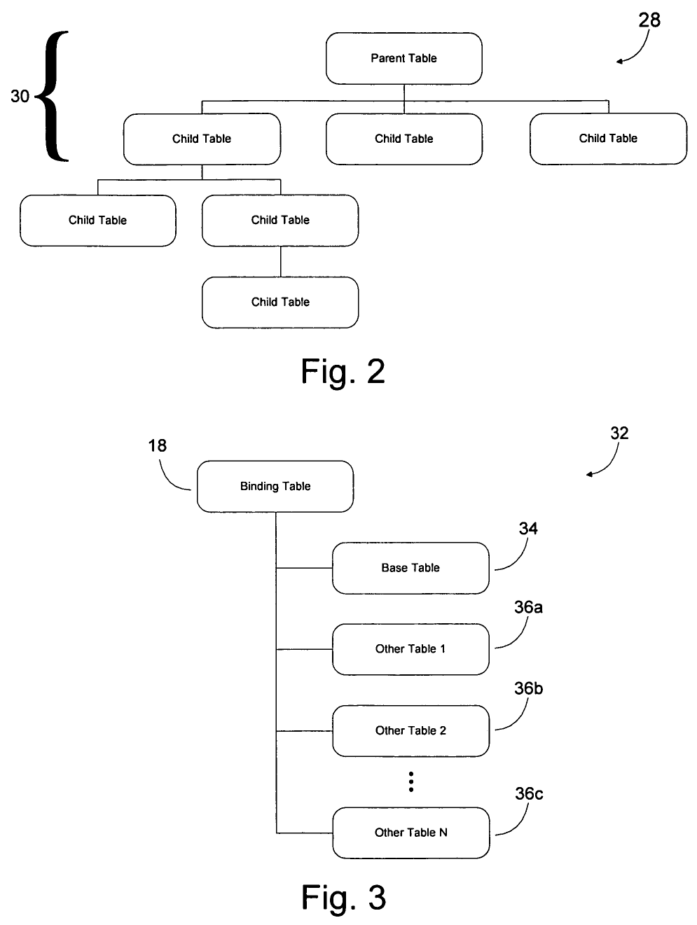

Referring now to FIG. 2 where a hierarchy chart (28) illustrating the typical hierarchical structure of a modern relational database system is shown. In a typical relational database system, tables are organized in parent-child relationships (30). Child tables are associated with parent tables via the use of indexes or keys which typically uniquely associate one or more rows of data in the child table with one row in the parent table. While the parent-child relationship is an efficient and logical method of storing large amounts of data, as a system grows, the complexity involved in performing meaningful ad hoc searches becomes prohibitive. To alleviate that complexity, the present system introduces a logical (i.e., not physical) flat hierarchy (FIG. 3, Item 32) over an existing database system. A universal binding table (18) is provided which includes all of the fields (columns) necessary to join with any other table in the database system. By defining the binding table (18) in this manner, only one level of join is required regardless of the complexity of the search to be performed. The results of the search of the base table (34) are used to limit the result set of the searches of the other tables (36a-c). The base table (34) and other tables (36a-c) are all tables existing in the database system. The base table (34) is assigned at runtime based upon the search criteria entered by the user.

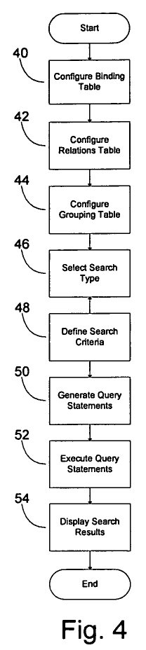

FIG. 4 is a flowchart illustrating the processing performed by the present invention. As a necessary precursor to use the method of the current invention, the universal binding table (18), the relations table (20), and the grouping table (22), must be configured (Steps 40, 42, 44). The binding table (18) is configured (Step 40) such that it may be joined with any desired table in a database system by any desired field of that table. The relations table is configured (Step 42) to store generic SQL code required to join any of the tables in the system to the binding table (18). In a later step of the present method, as discussed in more detail below, this generic SQL code is retrieved and processed so that the linking fields are prefixed with the correct table qualifiers as those qualifiers are stored in a table list. The modified SQL code is ultimately added to the SQL statement join clause. The grouping table (22) is configured (Step 44) to contain logical groupings of data to limit the result set of a query. Steps 40, 42, and 44 are required to be run only when a change to the structure of the database system occurs or the database administrator desires to alter relationships of the data.

The first step performed by a user of the present invention is the selection of a type of search to be performed (Step 46). Generally, searches are one of two types: listings or aggregations. A listing search returns a list of data matching a search criteria. In the example above, the search desired is a listing of the names and attendance rates of the 3rd grade students who failed a particular administration of a standardized test. An example of an aggregation of that search would be the average attendance rate of all 3rd grade students that failed a particular administration of a standardized test. Other types of searches, such as master-detail, are well known and contemplated by the present invention.

Once the search type has been selected (Step 46), the user is directed to define the search criteria (Step 48). The steps of defining the search criteria are enumerated below. Once the search criteria has been defined by the user, the system generates the appropriate query code (Step 50). The steps of generating the query code are enumerated below. The generated query code is then executed against the database (Step 52) and the search results are displayed to the user (Step 54). The step of displaying the results to the user may be printing the results to hard copy, displaying the results on a computer or terminal display, displaying the search results on a personal digital assistant, saving the search results to a document file, saving the search results to another database table, or any other way of representing the resulting data such that it may be perceived or manipulated by the user.

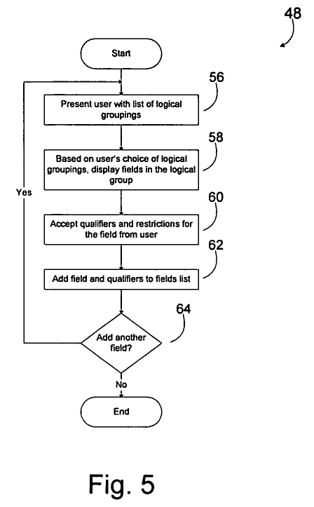

FIG. 5 is a flowchart illustrating the processing performed to retrieve the fields of the database the user would like to search or retrieve. In Step 56, the user is presented with a list of logical groupings of data. These logical groupings of data are stored in the groupings table (22). A logical grouping of data is comprised of a group name and the fields, from any table in the system, which logically belong to that group. For example, the fields street address and zip code are logical components of a Demographics group. It should be noted that the same field may appear in multiple logical groups. When a user selects one of the displayed logical groups, the user is presented with a list of all of the fields that are defined for that group (Step 58). Upon selecting a field to include in the query, the user has an opportunity to add optional qualifiers or restrictions (Step 60) which will limit the data returned for that field. For example, is the user wishes to display only results regarding males, the user may select the gender field and limit the result set to data wherein the gender is a male. When the user has completed added qualifiers or restrictions, the field and any defined qualifiers or restrictions is added to a selected fields list (Step 62). The selected fields list is an ordered list comprising each of the fields defined for a given query and the qualifiers and restrictions defined therefore. The selected fields list is used by the Generate Query Statement step (Step 50) to determine which tables and fields to include in a generated query statement and how those tables and fields are restricted. If the user desires to add another field (Step 64), the process is repeated from Step 56.

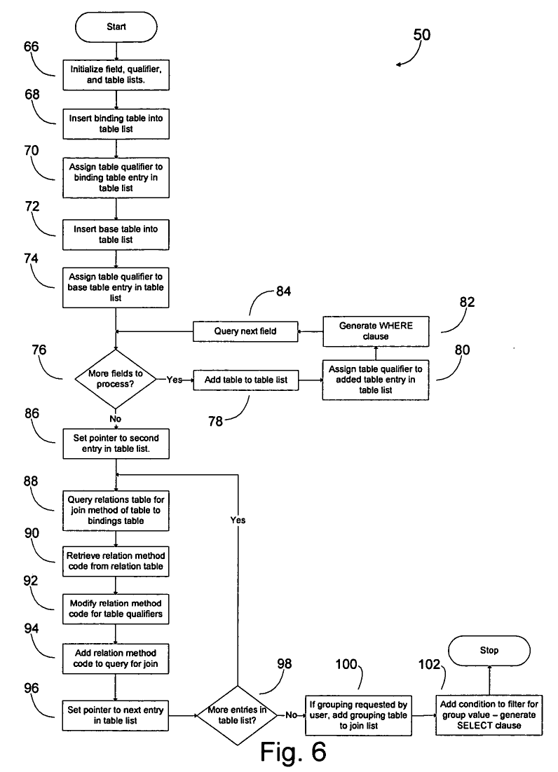

Referring now to FIG. 6 which is a flowchart illustrating the processing performed by the present invention to convert the user's field selection and qualifier and restriction definitions into SQL query code. The first step is to initialize the list of tables and table qualifiers that will be used in the generated query code (Step 66). The table list is a unique list of the tables that will be used in the query. The qualifier list is a list of the qualifiers that will be used to distinguish the tables in the table list. Next, the binding table is inserted as the first item in the table list (Step 68) and assigned a unique qualifier (Step 70). The base table (34) is then inserted as the second item in the table list (Step 72) and assigned a unique qualifier (Step 74). A pointer is then placed at the first field of the selected fields list. While there are more fields to process (Steps 76 and 84), the tables in which those fields are stored are uniquely added to the table list (Step 78) and assigned a unique qualifier (Step 80). If grouping was chosen by the user, the grouping table is queried to limit the result set of the generated query and added to the join statement and the group value conditional is added to the generated WHERE clause of the SQL code (Step 82). The next field is selected (Step 84) and the process begins again at Step 76.

Once the tables have been uniquely identified, the SQL code to join the various tables must be generated. A pointer is set to the second entry in the table list (Step 86). In the table list, the first entry is the binding table (18) and the second entry is the base table (34). In Step 88, the relations table (20) is queried using the name of the table in the table list to which the pointer is currently set. The generic code required to join the indicated table to the binding table is then retrieved (Step 90). The generic code is then modified so that the qualifier for the indicated table is properly placed in the generated SQL code (Step 92). The modified relation code is then added to the SQL join code (Step 94). The pointer is then set to the next entry in the table list (Step 96). If the pointer points to a valid table list entry (Step 98), Steps 88 through 96 are repeated for the new entry. If the user has requested grouping of search results, a join for the group filter table is next generated and the group value condition is added (Step 100).

Finally, using the assigned unique qualifier and the field name, the SELECT clause for each selected field is generated (Step 82) corresponding to field name and the conditionals assigned by the user and the qualifiers assigned by the system.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

What is claimed:

1. A method for providing ad hoc query capabilities to a database system, the database system comprised of a plurality of data tables to store application data, a binding table to function as a common joining table for said plurality of data tables, a relations table to store information required to join said binding table with each of said plurality of data tables, and a grouping table to store data to limit the result set of a search and to provide logical grouping information for the fields of said plurality of data tables, said grouping table comprising at least a group identifier, a joining key, and a group field, the method comprising the steps of:
configuring said binding, relations, and grouping tables;
allowing a user to select one search type from a plurality of search types;
displaying the group names stored in said grouping table to the user;
allowing the user to optionally select a group name on which to limit the search results, said group name selected from the grouping table;
displaying the field names in said plurality of data tables which are available for searching;
allowing the user to select the fields to be returned as a result set and assign zero or more conditionals to each selected field to filter the result set;
inserting each selected field and said zero or more qualifiers into a selected fields list;
inserting said binding table as the first element in a table list;
distinctly inserting each table associated with each field in said selected fields list into said table list, wherein the table associated with the first selected field is the base table;
assigning a unique qualifier to each table said table list;
iterating over said selected fields list to generate the SELECT and WHERE clauses for a database query, wherein said WHERE clause is generated only if one or more conditionals have been assigned to a selected field;
iterating over said table list starting from the base table, for each table in said table list, querying said relations table for the method of joining the tables in said table list to said binding table and generating the joining code for said database query;
if the user has selected to group the search results, generating code to join said grouping table with said binding table and the grouping code for said database query in accordance with the user's selected grouping choice;
executing said generated database query code against said plurality of database tables; and
displaying the result set to the user.

2. The method of claim 1 wherein the search type is an aggregation of the searched data.

3. The method of claim 1 wherein the search type is an listing of the searched data.

4. The method of claim 1 wherein the step of generating said SELECT and WHERE clauses occurs after the steps of generating said joining code.

5. A method for providing ad hoc query capabilities to a database system, the database system comprised of a plurality of data tables to store application data, a binding table to function as a common joining table for said plurality of data tables, a relations table to store information required to join said binding table with each of said plurality of data tables, and a grouping table to store data to limit the result set of a search and to provide logical grouping information for the fields of said plurality of data tables, said grouping table comprising at least a group identifier, a joining key, and a group field, the method comprising the steps of:
configuring said binding, relations, and grouping tables;
allowing a user to select one search type from a plurality of search types;
defining search criteria, said search criteria comprising tables and fields to be searched, optional conditionals to filter search results, and optional groupings to further limit search results;
building lists of fields and tables to be searched;
generating a database query to produce a result set comprising all data from the tables in said table list that match said search criteria;
executing the generated query code against said plurality of database tables; and
displaying the result set to the user.

6. The method of claim 5 wherein the search type is an aggregation of the searched data.

7. The method of claim 5 wherein the search type is an listing of the searched data.

8. The method of claim 5 wherein the step of defining search criteria across disparate tables comprises the steps of:
displaying the group names stored in said grouping table to the user;
allowing the user to optionally select a group name on which to limit the search results, said group name selected from the grouping table;
displaying the field names in said plurality of data tables which are available for searching; and
allowing the user to select the fields to be returned as a result set and assign zero or more conditionals to each selected field to filter the result set.

9. The method of claim 8 wherein the step of building lists of fields and tables to be searched comprises the steps of:
inserting each selected field and said zero or more qualifiers into a selected fields list;
inserting said binding table as the first element in a table list;
distinctly inserting each table associated with each field in said selected fields list into said table list, wherein the table associated with the first selected field is the base table; and
assigning a unique qualifier to each table said table list.

10. The method of claim 9 wherein the step of generating a database query comprises the steps of:
iterating over said selected fields list to generate the SELECT and WHERE clauses for a database query, wherein said WHERE clause is generated only if one or more conditionals have been assigned to a selected field;
iterating over said table list starting from the base table, for each table in said table list, querying said relations table for the method of joining the tables in said table list to said binding table and generating the joining code for said database query; and
if the user has selected to group the search results, generating code to join said grouping table with said binding table and the grouping code for said database query in accordance with the user's selected grouping choice.

11. The method of claim 10 wherein the step of generating said SELECT and WHERE clauses occurs after the steps of generating said joining code.

12. A system for providing ad hoc query capabilities to a homogenous or heterogeneous group of database tables, the system comprising:
a plurality of data tables wherein each of the plurality of data tables comprises fields representing the data of the system;
a binding table configured to function as a common joining mechanism for each of the plurality of data tables;
a relations table to store information required to join the binding table to each of the plurality of data tables;
a grouping table comprising data to limit the result set of a search and to provide logical grouping information for the fields of the plurality of data tables to a user wherein the grouping table stores at least a group identifier, a joining key, and a group field;
a means for interacting with a user to select one or more fields from one or more of the plurality of data tables to be queried and define zero or more conditional statements to filter the search result set from the queried tables;
a table list comprising the binding table and one or more of the plurality of data tables; and
a means for displaying search results to the user.

13. The system of claim 12 where in the means for interacting with the user is a computer terminal in electronic communication with a local area computer network.

14. The system of claim 12 where in the means for interacting with the user is a computer terminal in electronic communication with a wide area computer network.

15. The system of claim 12 where in the means for interacting with the user is a computer terminal in electronic communication with a computer network via the internet.

16. The system of claim 12 where in the means for interacting with the user is a personal digital assistant in electronic communication with a computer network.

17. The system of claim 12 where in the means for displaying search results to the user is a computer terminal display.

18. The system of claim 12 where in the means for displaying search results to the user is a hard copy printer.
